(19) United States
(12) Patent Application Publication
(10) Pub. No.: US 2001/0016253 A1
(43) Pub. Date: Aug. 23, 2001

(54) Glass article and glass substrate for display panel

(75) Inventors: Takuji Goda, Osaka (JP); Maki Nakamura, Osaka (JP); Toshiaki Mizuno, Osaka (JP)

Correspondence Address: KANESAKA AND TAKEUCHI, 1423 Powhatan Street, Alexandria, VA, 22314, US

(73) Assignee: NIPPON SHEET GLASS CO., LTD.

(21) Appl. No.: 09/755,047

(22) Filed: Jan. 8, 2001

(30) Foreign Application Priority Data
Jan. 19, 2000 (JP) 2000-10562
Nov. 10, 2000 (JP) 2000-343853

(51) Int. Cl. B32B 7/02

(52) U.S. Cl. 428/212

(57) ABSTRACT

A glass article having no problem of stain due to metal colloids because of its excellent efficiency of preventing the diffusion of metal ions, and a glass substrate for a high-quality display comprising the aforementioned glass article are provided. The glass article comprises an alkali-containing glass substrate 1, and a barrier film 2 formed on a surface of the alkali-containing glass substrate 1. The metal ion diffusion barrier film 2 mainly contains indium oxide and/or tin oxide. A glass substrate for a display comprises: an alkali-containing glass substrate 1; an alkali ion diffusion barrier film 5 formed on a surface of said alkali-containing glass substrate 1; a barrier film 2 mainly containing indium oxide and/or tin oxide; an insulating film 3; and an electrode film 4. The surface electrical resistance of the insulating film is kept in a range from 1.0×10⁶ Ω/□ to 1.0×10¹⁶ Ω/□ even after heating process at 550° C. for 1 hour.

### FIELD OF THE INVENTION AND RELATED ART STATEMENT

The present invention relates to a glass article on which a barrier film is formed, the film being capable of exhibiting excellent effect of preventing single or mutual diffusion of alkali in glass and metal when a metal film is formed on a surface of glass containing alkali, and to a glass substrate for display panel.

Generally, a flat display panel such as a plasma display panel (PDP), a field emission display (FED), a liquid crystal display (LCD), or an electroluminescent display (ELD) is made by forming members such as electrodes on two glass substrates and laminating the glass substrates. Especially for the front glass substrates, transparent electrodes such as ITO (Indium-Tin-Oxide) and SnO₂ are employed. Metals such as Ag, Cr/Cu/Cr are employed as auxiliary electrodes particularly for a large area display, in order to decrease resistance in wiring for electrodes.

In a glass substrate for a PDP, a soda lime silicate glass substrate formed in a plate shape having a thickness of 1.5 mm - 3.5 mm or an alkali-containing glass plate with high strain point is used. Such glass substrate is produced by using a float process that is suitable for mass production and for obtaining an excellent flatness of the surface. During the process, float glass is exposed to hydrogen gas atmosphere, so that a reduction layer of a several microns thickness is formed on a surface thereof. It is generally known that such a reduction layer contains Sn²⁺ derived from melted Sn.

In the manufacturing process of the PDP, the application of Ag as a bus electrode onto a surface of a glass substrate via transparent electrodes is followed by heating to a temperature from 550° C. to 600° C. for 20 - 60 minutes, and the process is repeated for several times.

In this heating process, Ag⁺ ions are diffused into the transparent electrodes and reach the glass surface where ion exchange between Ag⁺ ions and Na⁺ ions contained in the glass takes place. As a result of this, Ag⁺ ions migrate into the glass and the migrated Ag⁺ ions are reducted by Sn²⁺ existing in the reduction layer whereby colloids of Ag are formed. Due to the Ag colloids, the glass substrate is stained yellow.

Such problem of stain due to metal colloids may be occurred not only in case of forming Ag metal electrode film, but also in case of forming another electrode film of a metal such as Cu or Au which diffuses easily. The problem of the stain due to the Ag colloids may occur also in a rear window glass of an automobile having striped Ag electrodes for defogging.

It has been proposed that, in case of using alkali-containing glass as a substrate for a display, a barrier film is formed to prevent metal ions to diffuse whereby preventing ion exchange between alkali in the glass and Ag or the like used as electrodes in case of PDP and thus preventing the stain of the glass due to Ag colloids, wherein the barrier film is made of a metal, a nitride, or an oxide such as SiO₂, ZrO₂, Al₂O₃, and TiO₂ (Japanese patent H09-245652A, Japanese patent H10-114549A, Japanese patent H10-302648A, Japanese patent H11-109888A, and Japanese patent H11-130471A).

However, the barrier film can not offer sufficient efficiency of preventing the diffusion of metal ions. In particular, the barrier film of the nitride is oxidized in a heating process in a PDP manufacturing process, thus reducing the efficiency of preventing the diffusion of metal ions.

### OBJECT AND SUMMARY OF THE INVENTION

It is the object of the present invention to solve the aforementioned problems and to provide a glass article having no problem of stain due to metal colloids because of its excellent efficiency of preventing the diffusion of metal ions, and to provide a glass substrate for a high-quality display comprising the aforementioned glass article.

The glass article of the present invention has an alkali-containing glass substrate, and a barrier film formed on a surface of the alkali-containing glass substrate for preventing metal ions diffuse. The barrier film mainly consists of indium oxide and/or tin oxide.

The barrier film mainly consisting of indium oxide (In₂O₃) and/or tin oxide (SnO₂) has excellent efficiency of preventing diffusion of metal ions and thus can effectively prevent elution of alkali contained in glass and prevent diffusion of metal ions contained in a metal film formed on the surface of the glass plate into the glass.

When the barrier film is directly formed on the alkali-containing glass plate, the alkali ingredient contained in the glass affects the compactness of the barrier film formed thereon, thus affecting the efficiency of preventing diffusion of metal ions.

That is, when the diffusion barrier film is formed by a physical vapour deposition method such as a sputtering method, an ion plating method, or a vacuum evaporation method, alkali is diffused in a trace amount from the glass during the film formation and the diffusion of alkali may affects the crystal structure of the barrier film. In case of a large amount of diffused alkali, the crystal structure of the barrier film is deteriorated so that the barrier film becomes porous, thus decreasing the efficiency of preventing the diffusion of metal ions.

When the barrier film for preventing diffusion of metal ions is formed by an application method such as a printing method or a sol/gel method, the application process should be followed by a baking or firing process. The above crystal structure of the barrier film may be deteriorated during the baking or firing process after the application of diffusion barrier material.

When the barrier film is formed by a chemical vapour deposition (CVD) method such as a chemical gaseous phase deposition method, the same phenomenon as the case of using the physical vapour deposition method is occurred. When the barrier film is formed by the CVD method, source material used in the method generally contains chlorine so that the material liberates the chlorine during the film formation and the chlorine reacts with alkali ingredient contained in the glass substrate so as to deposit chlorine compounds on the glass substrate. Portions where the chlorine compounds are formed do not allow the formation of the above barrier film mainly consisting of indium oxide and/or tin oxide so that the barrier film has pin holes. The diffusion of metal ions can not be prevented at such portions.

Accordingly, in order to remove the affection due to alkali contained in the glass substrate, an under layer for preventing diffusion of alkali ions (hereinafter, sometimes referred to just as “under layer”) is previously formed on the alkali-containing glass substrate. The barrier film mainly consisting of indium oxide and/or tin oxide is formed on the under layer, thereby exhibiting the effect of securely preventing the diffusion of metal ions.

In the glass article of the present invention, an insulating film is formed on the barrier film, if necessary, and an electrode film, preferably including Ag, is further formed on the insulating film.

The surface electrical resistance of the insulating film is preferably in a range from 1.0×10⁶ Ω/□ to 1.0×10¹⁶ Ω/□. The surface electrical resistance of the insulating film is preferably kept in the range from 1.0×10⁶ Ω/□ to 1.0×10¹⁶ Ω/□ even after heating process at 550° C. for 1 hour, i.e. the heating conditions of usual manufacturing process of PDPs.

The glass substrate for a display of the present invention comprises an alkali-containing glass substrate, an under layer for preventing diffusion of alkali ions formed on a surface of the alkali-containing glass substrate, a barrier film mainly consisting of indium oxide and/or tin oxide for preventing diffusion of metal ions, an insulating film, and an electrode film. The surface electrical resistance of the insulating film is in a range from 1.0×10⁶ Ω/□ to 1.0×10¹⁶ Ω/□ even after heating process at 550° C. for 1 hour. The glass substrate for a it display has no stain due to metal colloids because of the excellent efficiency of preventing the diffusion of metal ions of the barrier film so as to have significantly high quality.

### BRIEF DESCRIPTION OF THE DRAWINGS

FIG. 1 is a sectional view showing an embodiment of the glass article of the present invention;

FIG. 2 is a sectional view showing another embodiment of the glass article of the present invention;

FIG. 3 is a sectional view showing further another embodiment of the glass article of the present invention; and

FIG. 4 is a sectional view showing still another embodiment of the glass article of the present invention.

### DETAILED DESCRIPTION OF PREFERRED EMBODIMENTS

Hereinafter, preferred embodiments of the present invention will be described with reference to the attached drawings.

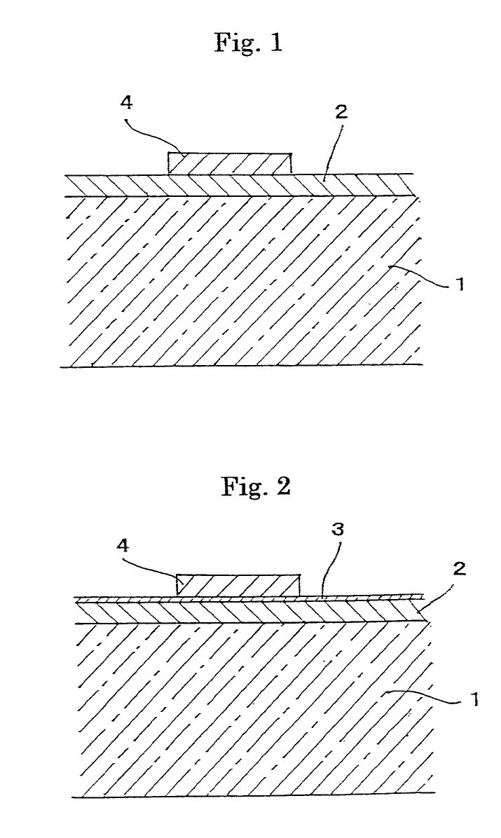

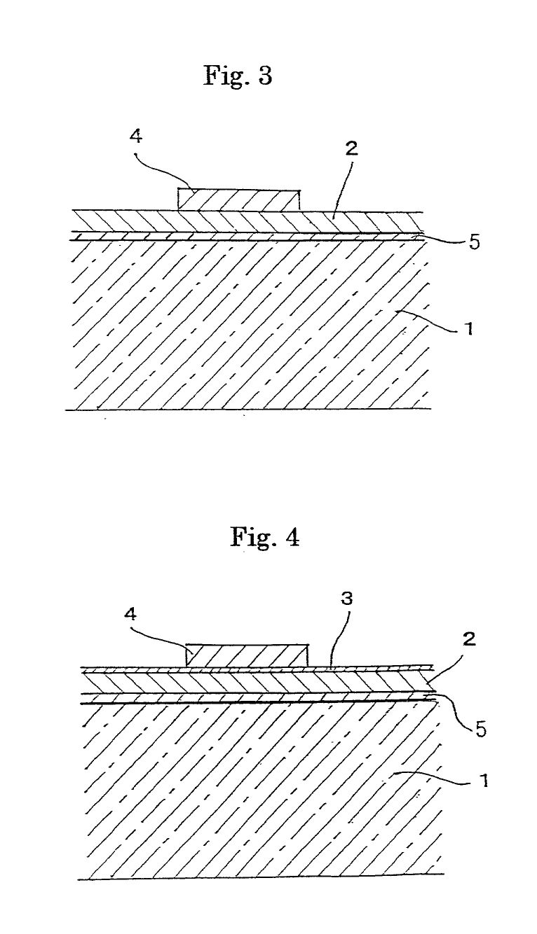

FIGS. 1-4 are sectional views each showing a glass article according to each embodiment of the present invention, in which a barrier film 2 is formed on a glass substrate 1 and a metal electrode film 4 is formed on the barrier film 2 directly (FIG. 1) or, if necessary, via an insulating film 3 (FIG. 2). Alternatively, the barrier film 2 is formed on the glass substrate 1 via an under layer 5 and the metal electrode film 4 is formed on the barrier film 2 directly (FIG. 3) or, if necessary, via the insulating film 3 (FIG. 4).

The glass substrate 1 is made of alkali-containing glass. Preferable main components of the alkali-containing glass are as follows:

| | |
|---|---|
| SiO₂ | 50-73 mass % |
| Al₂O₃ | 0-15 mass % |
| R₂O | 6-24 mass % |
| R′O | 6-27 mass % |

R₂O is the sum of Li₂O, Na₂O, and K₂O, and R′O is the sum of CaO, MgO, SrO, and BaO.

The barrier film 2 mainly consisting of In₂O₃ and/or SnO₂.

A film mainly consisting of In₂O₃ or SnO₂ is generally used as a transparent conductive film. In particular, an In₂O₃ film containing 5 mass % Sn (ITO) and a SnO₂ film in which fluorine or antimony is doped are preferably used because of their low surface electrical resistance. According to the present invention, there is no special limitation on impurity concentration in the barrier film 2 because the diffusion of metal ions can be prevented regardless of the value of surface electrical resistance. However, when the barrier film 2 is used also as an electrode, the aforementioned composition having low surface electrical resistance is preferably used as the barrier film 2. In case of application necessitating high surface electrical resistance such as a rear window glass of an automobile and a substrate for a display, the insulating film 3 is preferably formed on the barrier film 2 mainly consisting of In₂O₃ and/or SnO₂ as shown in FIG. 2.

The barrier film 2 does not have special limitation on the ratio between In₂O₃ content and SnO₂ content.

The barrier film 2 may mainly contain SnO₂ and additionally contain Sb₂O₃, wherein the preferable ratio between them is SnO₂: Sb₂O₃=99.9-99.99:0.01-0.1 (mass %).

As for the barrier film 2 for preventing the diffusion of metal ions, the greater thickness is preferable in view of diffusion barrier effectiveness of metal ions. However, too great thickness can not offer the corresponding effect and, conversely, increases the cost. Accordingly, the thickness of the barrier film 2 is preferably in a range from 5 nm to 200 nm, particularly, in a range from 50 nm to 200 nm.

The surface electrical resistance of the insulating film 3 is preferably in a range from 1.0×10⁶ Ω/□ to 1.0×10¹⁶ Ω/□. Particularly for a PDP in which leak current should be significant problem, high surface electrical resistance more than 1.0×10¹⁵ Ω/□ e.g. in a range from 1.0×10¹⁵ Ω/□ to 1.0×10¹⁶ Ω/□ is preferable. For a FED in which electrification of substrate should be significant problem, the surface electrical resistance is preferably in a range from 1.0×10⁶ Ω/□ to 1.0×10¹² Ω/□ and, more preferably, in a range from 1.0×10⁸ Ω/□ to 1.0×10¹² Ω/□.

Since leak current and/or electrification of substrate should be significant problem when the glass substrate is used as a display, the above ranges for the surface electrical resistance should be kept even after the heating process at 550° C. for one hour, that is, should not vary depending on the temperature effects during the panel manufacturing process, for example, the baking or firing condition of Ag electrode.

The insulating film 3 being too thick may have problem of cracks and increase in the cost, while the insulating film 3 being too thin may not offer stable surface electrical resistance. Accordingly, the preferable thickness of the insulating film 3 is in a range from 25 nm to 200 nm.

There is no special limitation on the material of the insulating film 3. The insulating film 3 may be made of any material achieving the desired surface electrical resistance and is preferably made of high-resistance film such as SiO₂, Al₂O₃, TiO₂, TiON, ZrON, or ZnAlO.

According to the present invention, the barrier film 2 or the insulating film 3 can be easily formed on the glass substrate 1 by a physical vapour deposition (PVD) method such as a sputtering method, an ion plating method, or a vacuum evaporation method, a chemical vapour deposition (CVD) method such as a chemical gaseous phase deposition method, a printing method, a sol/gel method, or other method.

There is no special limitation on the material of the under layer 5 formed between the barrier film 2 and the glass substrate 1. The under layer 5 formed between the barrier film 2 and the glass substrate 1 may be made of any material capable of preventing the diffusion of alkali ions (e.g. Na⁺, K⁺) and is preferably made of oxide or nitride such as SiO₂, TiO₂, ZnO, Al₂O₃, ZrO₂, MgO, SiN, TiN, or AlN. Among these materials for the under layer 5, the oxide such as SiO₂, ZnO having excellent workability is better than the others in view of the adhesion at the interface because the barrier film 2 formed on the under layer 5 is made of oxide film.

The under layer 5 can be formed by a physical vapour deposition (PVD) method such as a sputtering method, an ion plating method, or a vacuum evaporation method, a chemical vapour deposition (CVD) method such as a chemical gaseous phase deposition method, a printing method, a sol/gel method, or any other method. The forming method and the forming condition should be selected such that a thin layer made of the aforementioned material has a compact structure. Among these methods, the sputtering method is suitably employed because it can facilitate the formation of a thin film having a compact structure and have wide applicable range to film materials. The use of the same method used for forming the barrier film 2 and the insulating film 3 is advantageous from the industrial standpoint because the glass article of the present invention can be manufactured in a relatively short process.

The thickness of the under layer 5 may be greater than 10 nm. With the thickness smaller than 10 nm, the formation of a uniform film is impossible and the formed film may be like islands. Therefore, the desired thickness of the under layer 5 is greater than 10 nm for completely preventing the diffusion of alkali ions. There is no special upper limit on the thickness, but sufficient effect as the under layer 5 can be exhibited with a thickness not greater than 50 nm. From the industrial standpoint, the preferred thickness of the under layer 5 is in a range from 20 nm to 30 nm.

In case of forming the metal electrode film 4 made of Ag or the like on the barrier film 2 or the insulating film 3, the preferred thickness of the metal electrode film 4 is in a range from 3 μm to 12 μm.

### EXAMPLES

The present invention will be concretely described with reference to the following examples and comparative examples.

### Example 1

A soda lime glass substrate was prepared by using the float process. An In₂O₃ film was formed as the barrier film for preventing the diffusion of metal ions on the soda lime glass substrate by the sputtering method. The film was formed to have a thickness shown in Table 1 by using an In target, in an atmosphere of argon-oxygen, and at a pressure 0.4 Pa (3×10⁻³ Torr), and in the DC mode. Then, an Ag electrode of 8 μm in thickness was formed by printing Ag paste on the In₂O₃ film and baking it at 550° C. for 1 hour. The degree of stain was visually observed and the result is shown in Table 1.

Examples 2-5, Comparative Examples 1-3

Each barrier film shown in Table 1 was formed to have a thickness shown in Table 1 by the sputtering method in the same manner as Example 1, but using different kind of target and different film-forming atmosphere. After that, an Ag electrode was formed in the same manner as Example 1. The degree of stain was observed and the result is shown in Table 1.

### Example 6

A barrier film of SnO₂ having a thickness shown in Table 1 was formed by heating a soda lime silica glass substrate to 550° C., blowing a mixed gas of monobutyl tin trichloride (MBTC), oxygen, nitrogen, and water vapor, and using the CVD method. After that, an Ag electrode was formed in the same manner as Example 1. The degree of stain was observed and the result is shown in Table 1.

### Comparative Example 4

A barrier film of SiO₂ having a thickness shown in Table 1 was formed by a CVD method in the same manner as Example 6, but using monosilane instead of the MBTC and using ethylene instead of the water vapor. After that, an Ag electrode was formed in the same manner as Example 1. The degree of stain was observed and the result is shown in Table 1.

### Examples 7 - 11

Each under layer shown in Table 1 was formed prior to the formation of a barrier film on a soda lime glass substrate as formed in Examples 1, 2, 3, and 6.

As for Example 7 - 10, the under layer was formed to have a thickness of 20 nm by the sputtering method using an oxide target and in RF mode. As for Example 11, the under layer was formed to have a thickness of 20 nm by the CVD method just like Comparative Example 4.

As for Example 7, a barrier film was formed in the same manner as Example 1 after forming the under layer of SiO₂.

As for Example 8, a barrier film was formed in the same manner as Example 1 after forming the under layer of TiO₂.

As for Example 9, a barrier film was formed in the same manner as Example 2 after forming the under layer of SiO₂.

As for Example 10, a barrier film was formed in the same manner as Example 3 after forming the under layer of SiO₂.

As for Example 11, a barrier film was formed in the same manner as Example 6 after forming the under layer of SiO₂.

After that, an Ag electrode was formed for each example in the same manner as Example 1 respectively. The degree of stain was observed for each example and the results are shown in Table 1.

TABLE 1

| | | Example | | | | | | | |
|---|---|---|---|---|---|---|---|---|---|
| | | 1 | 2 | 3 | 4 | 5 | 6 | 7 | 8 |
| Bedding | Kind *1 | — | — | — | — | — | — | SiO₂ | TiO₂ |
| Film | Thickness | — | — | — | — | — | — | 20 | 20 |
| | (nm) | | | | | | | | |
| | Film- | — | — | — | — | — | — | Sputtering | Sputtering |
| | forming | | | | | | | | |
| | method | | | | | | | | |
| Metal | Kind *1 | IN₂O₃ | SnO₂ | 95% | 50% | 99.95% | SnO₂ | In₂O₃ | In₂O₃ |
| Ion | | | | IN₂O₃- | In₂O₃- | In₂O₃- | | | |
| | | | | 5% SnO₂ | 50% SnO₂ | 0.05%SnO₂ | | | |
| Diffusion | Thickness | 100 | 100 | 100 | 100 | 100 | 100 | 100 | 100 |
| Barrier | (nm) | | | | | | | | |
| Film | Film- | Sputtering | Sputtering | Sputtering | Sputtering | Sputtering | CVD | Sputtering | |
| | forming | | | | | | | | |
| | method | | | | | | | | |

| | | | | | | | | |
|---|---|---|---|---|---|---|---|---|
| Degree of | ◯ | ◯ | ◯ | ◯ | ◯ | ◯ | ⊚ | ⊚ |
| Stain *2 | | | | | | | | |

| | | Example | | | Comparative Example | | | |
|---|---|---|---|---|---|---|---|---|
| | | 9 | 10 | 11 | 1 | 2 | 3 | 4 |
| Bedding | Kind *1 | SiO₂ | SiO₂ | SiO₂ | — | — | — | — |
| Film | Thickness | 20 | 20 | 20 | — | — | — | — |
| | (nm) | | | | | | | |
| | Film- | Sputtering | Sputtering | CVD | — | — | — | — |
| | forming | | | | | | | |
| | method | | | | | | | |
| Metal | Kind *1 | SnO₂ | 95% IN₂O₃- | SnO₂ | SiO₂ | TiN | 97% ZnO- | SiO₂ |
| Ion | | | 5%SnO₂ | | | | 3% Al₂O₃ | |
| Diffusion | Thickness | 100 | 100 | 100 | 40 | 100 | 50 | 100 |
| Barrier | (nm) | | | | | | | |
| Film | Film- | Sputtering | Sputtering | CVD | Sputtering | Sputtering | Sputtering | CVD |
| | forming | | | | | | | |
| | method | | | | | | | |

| | | | | | | | |
|---|---|---|---|---|---|---|---|
| Degree of | ⊚ | ⊚ | ⊚ | Δ | X | Δ | X |
| Stain *2 | | | | | | | |

*1: indicated by mass %
*2:
⊚ none
◯ little or slightly stained
Δ stained
X heavily stained

It is found from Table 1 that the examples according to the present invention can exhibit effect of significantly preventing the stain due to Ag colloids produced by the diffusion of Ag ions. Particularly, it is also found that the under layer further improves the effect.

As described in detail, the present invention can provide a glass article having no problem of stain due to metal colloids because of its excellent efficiency of preventing the diffusion of metal ions, and provide a glass substrate for a high-quality display comprising the aforementioned glass article.

The glass articles of the present invention is extremely industrially useful as a substrate for a display, a rear window glass for an automobile, and the like.

What is claimed is:

1. A glass article comprising an alkali-containing glass substrate, and a barrier film for preventing diffusion of metal ions formed on a surface of said alkali-containing glass substrate, wherein said barrier film mainly consisting of indium oxide and/or tin oxide.

2. A glass article as claimed in claim 1, wherein said article further comprises an under layer for preventing diffusion of alkali ions formed on the surface of said alkali-containing glass substrate, and wherein said barrier film is formed on said under layer.

3. A glass article as claimed in claim 1 or 2, further comprising an insulating film formed on said barrier film.

4. A glass article as claimed in claim 3, wherein the surface electrical resistance of said insulating film is in a range from 1.0×10⁶ Ω/□ to 1.0×10¹⁶ Ω/□.

5. A glass article as claimed in claim 3 or 4, wherein the surface electrical resistance of said insulating film is kept in the range from 1.0×10⁶ Ω/□ to 1.0×10¹⁶ Ω/□ even after heating process at 550° C. for 1 hour.

6. A glass article as claimed in any one of claims 3 through 5, further comprising an electrode film formed on said insulating film.

7. A glass article as claimed in claim 6, wherein said electrode film includes Ag.

8. A glass substrate for a display comprising: an alkali-containing glass substrate; an under layer for preventing diffusion of alkali ions formed on a surface of said alkali-containing glass substrate; a barrier film for preventing diffusion of metal ions mainly consisting of indium oxide and/or tin oxide; an insulating film; and an electrode film,
said films being formed in the enumerated order, and
the surface electrical resistance of said insulating film being kept in a range from 1.0×10⁶ Ω/□ to 1.0×10¹⁶ Ω/□ even after heating process at 550° C. for 1 hour.
